(19) United States
(12) Patent Application Publication
(10) Pub. No.: US 2009/0050858 A1
(43) Pub. Date: Feb. 26, 2009

(54) INDIUM-TIN MIXED OXIDE POWDER

(76) Inventors: Stipan Katusic, Kelkheim (DE); Horst Miess, Kahl (DE); Edwin Staab, Geiselbach (DE); Guido Zimmermann, Rodenbach (DE); Sven Hill, Aschaffenburg (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/574,020

(22) PCT Filed: Jul. 26, 2005
(86) PCT No.: PCT/EP05/08088

§ 371 Date: Oct. 20, 2008

(30) Foreign Application Priority Data
Aug. 28, 2004 (DE) 10 2004 041 747.4

(51) Int. Cl. H01B 1/08

(52) U.S. Cl. 252/520.1

(57) ABSTRACT

Indium-tin mixed oxide powder which consists of primary particle aggregates and contains 50 to 90% by weight indium oxide, calculated as In₂O₃, and 10 to 50% by weight tin oxide, calculated as SnO₂. It is produced by atomising a solution of an inorganic indium compound and an organic tin compound and burning it in a flame. It may be used for the production of electrically conductive paints and coatings, solar cells and IR and UV absorbers and in medical technology.

The invention relates to an indium-tin mixed oxide powder and to the production and use thereof.

The importance of indium-tin mixed oxide resides in its good electrical conductivity and simultaneous high transparency. It is used predominantly for producing coatings, for example for contact screens or electromagnetic waves shielding.

Indium-tin mixed oxide powders are generally obtained by gas phase deposition processes. In these processes, the powder is deposited in a thin layer on a substrate. This process is expensive and unsuitable for coating relatively large areas.

The indium-tin mixed oxide powder may also be obtained from an aqueous solution by reaction of water-soluble indium and tin salts in the presence of alkaline substances. Hydroxides are initially formed and may then be calcined in a following step. DE-A-100 22 037 describes, for example, the calcination of these hydroxides under reducing conditions at temperatures between 200 and 400° C. for residence times between 15 and 120 minutes. The indium-tin mixed oxide powder produced in this way is dark brown in colour. This powder may be suitable for producing IR-absorbing compositions. However, its resistance is too high for use in electrically conductive paints and coatings. A brown colouring is also undesirable for many fields of application of indium-tin mixed oxide powders.

WO 00/14017 discloses a process for producing an indium-tin oxide powder in a liquid medium, during which an indium-tin oxide precursor is initially isolated, is then calcined and is subsequently dispersed in the presence of a surface-modifying component. An almost unaggregated powder remains after separation of the liquid components.

A few pyrolysis processes are also known from the prior art. JP 05-024836 discloses a process in which indium and tin chloride vapour is rapidly cooled to temperatures of 400° C. or less, and the particles obtained are treated with steam and/or oxygen at temperatures of 500° C. or higher.

EP-A-1277703 discloses a process for producing indium-tin mixed oxide powders by spray pyrolysis of a solution containing a total of at least 3.0 mol/l indium nitrate and tin chloride. Pyrolysis can be carried out in a flame or by means of external heating. The resultant powders have a small BET specific surface area and a large average particle size in the μm range.

EP-A-1142830 discloses the production of nano-scale oxides by pyrolysis of organometallic precursors. The reaction of indium and tin oxide precursors under these conditions is also claimed. Experiments have shown that indium-tin mixed oxide powders having good electrical conductivity cannot be obtained by the process disclosed in EP-A-1142830.

EP-A-1270511 discloses indium-tin mixed oxide powders and doped indium-tin mixed oxide powders which are obtained by pyrolysis of an indium salt and a tin salt. X-ray structural analysis of the powders produced in this way shows cubic indium oxide and tetragonal tin oxide. The conductivity of these powders is too low for many applications in the field of electrically conductive paints and coatings.

The unpublished German patent application No; 10311645.1-41 with the application date of 14 Mar. 2003 describes an indium-tin mixed oxide powder having an indium oxide content of at least 90% by weight and a BET specific surface area of 40 to 120 m²/g. It is in the form of aggregates having an average circumference of less than 500 nm and shows only one cubic indium oxide phase in X-ray diffraction analysis. A further characteristic is that the powder has an oxygen content which is less than the content theoretically resulting from In₂O₃ and SnO₃.

It is produced by atomising a solution, which contains an indium compound and a tin compound, pyrolysing it in a first zone and adding reducing gases to the pyrolysis mixture at one or more points in a quantity in a second zone of the reactor. The solid obtained is separated from the exhaust gases in a further third zone, in which there is also still a reducing atmosphere.

The powder produced by this process has good electrical conductivity and transparency. As in the other prior art, the only drawback is that a high proportion of indium oxide, generally more than 90%, is required for achieving high conductivity. As the indium component is the much more expensive in the mixed oxide, a powder which exhibits similarly good conductivity values and can at the same time be produced more favourably would however be desirable.

It is accordingly an object of the invention to provide a nano-scale indium-tin mixed oxide powder having high electrical conductivity, which has a reduced indium content relative to the prior art.

A further object of the invention is to provide a process for producing the indium-tin mixed oxide powder.

The invention relates to an indium-tin mixed oxide powder which consists of primary particle aggregates and contains 50 to 90% by weight indium oxide, calculated as In₂O₃, and 10 to 50% by weight tin oxide, calculated as SnO₂.

In a preferred form, the indium-tin mixed oxide powder can contain 60 to 85% by weight indium oxide, calculated as In₂O₃, and 15 to 40% by weight tin oxide, calculated as SnO₂.

The proportions of indium oxide and tin oxide are standardised to 100% by weight. In addition, however, the indium-tin mixed oxide powder can also have impurities from the substances used or impurities formed during processing. These impurities are less than 1% by weight and generally less than 0.5% by weight in total, based on the total amount of powder in each case.

Thus the powder according to the invention can contain up to 0.3% by weight of carbon. The carbon content is usually less than 0.2% by weight, based on the total amount of powder in each case.

Purposeful doping of a powder basically differs from contamination. The indium-tin mixed oxide powder according to the invention can accordingly contain up to 3% by weight, particularly preferably 0.01 to 1% by weight, based on the total amount of powder, and also one or more metals and/or metal oxides as a doping component. Suitable doping components include oxides and/or elemental metals from the group consisting of aluminium, antimony, cadmium, calcium, cerium, iron, gold, iridium, potassium, cobalt, copper, magnesium, sodium, nickel, manganese, palladium, platinum, osmium, rhodium, ruthenium, tantalum, titanium, silver, silicon, vanadium, yttrium, tungsten, zinc and zirconium. Potassium (oxide), platinum or gold may be particularly preferred as the doping component.

The indium-tin mixed oxide powder according to the invention is in the form of primary particle aggregates. The dimensions of the aggregates depend on the substances used and the reaction conditions. Powders having an average aggregate area of 1500 to 4500 nm², an average equivalent diameter (ECD) of 30 to 70 nm and an average aggregate diameter of 200 to 600 nm may be advantageous. An indium-tin mixed oxide powder according to the invention having an average aggregate area of 2500 to 4000 nm², an average diameter (ECD) of 40 to 60 nm and an average aggregate circumference of 300 to 500 nm may be particularly advantageous.

Indium-tin mixed oxide powders which have an average minimum diameter of 30 to 70 nm and an average maximum diameter of 60 to 120 nm may also be advantageous.

The BET specific surface area of the indium-tin mixed oxide powder according to the invention is unrestricted. It may preferably be 30 to 70 m²/g, a range of 40 to 60 m²/g being particularly preferred.

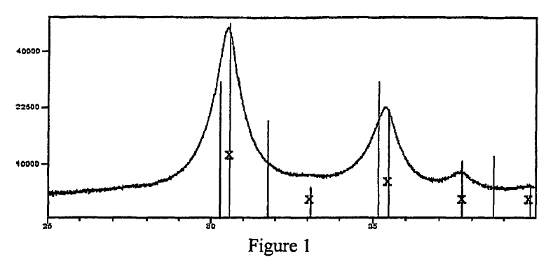

The indium-tin mixed oxide powder according to the invention preferably has only one indium oxide phase in X-ray diffraction analysis. Indium oxide signals which are slightly offset relative to an In₂O₃ standard (ICDD No. 6-416) are generally detected (see FIG. 1; example with 36% by weight tin oxide; X=In₂O₃ standard). On the other hand, there is no tin oxide phase, even with very high tin oxide contents. The reason for this has not yet been explained.

The invention further relates to a process for producing the indium-tin mixed oxide powder wherein
as the indium oxide precursor, an inorganic indium compound, which contains no chlorine atoms, dissolved in a mixture of water and solvent, selected from the group consisting of C₁ to C₆ alcohols, C₁ to C₆ diols and/or C₁ to C₆ glycolmonoalkylethers, wherein the pH of the solution is optionally adjusted using an acid to a value of 3≧pH≧1, and
as the tin oxide precursor, an organic tin compound, dissolved in at least one solvent, selected from the group consisting of C₁ to C₆ alcohols, C₁ to C₆ diols, C₁ to C₆ glycolmonoalkylethers and/or C₁ to C₈ carboxylic acid,
are combined to form a precursor solution, the respective precursor content in the combined solution being not more than 20% by weight of indium and tin, based on In₂O₃ and SnO₂, and the precursor content corresponding to the subsequently desired ratio of mixed oxide components,
the precursor solution is atomised with an atomising gas, preferably air or an inert carrier gas, using a nozzle, and
is mixed with a fuel gas and air (primary air)
the mixture of fuel gas, air (primary air) and atomised precursor solution is left to burn in a flame into a reaction pipe,
the hot gases and the solid products are cooled and the solid product is subsequently separated from the gases,
   wherein
the proportion of precursor solution in the total quantity of gas consisting of atomising gas, air (primary air) and fuel gas is from 10 to 100 g solution/Nm³ gas,
lambda, defined as the ratio of oxygen present from the air used to oxygen required for combustion of the fuel gas, is 2 to 4.5, and
the precursors remain in the flame for a residence time of 5 to 30 milliseconds and
the temperature of the reaction mixture 0.5 m below the flame is 700 to 800° C.

It may be advantageous if secondary air or an inert gas is also supplied to the reaction pipe in addition to the primary air. The temperature in the reaction zone and therefore the powder properties may therefore be varied. The amount of secondary air or inert gas is preferably between 50% and 150% of the amount of primary air.

Suitable fuel gases include hydrogen, methane, ethane, propane and/or natural gas, hydrogen being particularly preferred.

It is particularly preferable to use indium nitrate as the indium oxide precursor.

A tin(II)carboxylate, such as bis-(2-ethyl-hexanoate) tin, bis-(2-isooctanoate) tin, dibutyltin dilaurate, dioctyltin dilaurate, monobutyltin tris-2-ethylhexanoate, dibutyltin didecanoate, dibutyltin diisooctoate, dibutyltin diacetate, dibutyltin maleate may preferably be used as the organic tin compound. It is particularly preferable to use bis-(2-ethyl-hexanoate) tin.

The choice of C₁ to C₆ alcohol, C₁ to C₆ diol, C₁ to C₆ glycolmonoalkylether and C₁ to C₈ carboxylic acid depends predominantly on the indium oxide and tin oxide precursors used and the concentration thereof. It is essential to select the quantities in such a way that, when the solution of the indium oxide precursor is combined with the tin oxide precursor, no cloudiness or precipitates form in the solution, at least within the atorisation time, as a powder according to the invention could not otherwise be obtained.

The flame parameters such as the flame temperature may also be influenced by the choice of the organic solvent or solvent mixture which is reacted to form carbon dioxide and water in the reaction. Substance parameters such as BET specific surface area or aggregate sizes may thus be varied.

It is also essential to carry out the process in such a way that the solutions of the precursors are combined prior to atomisation. Separate atomisation of the precursor solutions does not lead to an indium-tin mixed oxide powder according to the invention.

Methanol, ethanol, n-propanol, iso-propanol, n-butanol, ethyleneglycol and isopropylglycol have proven to be particularly suitable solvents.

A C₁ to C₄ carboxylic acid may preferably be used as the acid for adjusting the pH. Acetic acid and lactic acid may be particularly preferred.

The solution of the tin oxide precursor can preferably contain 2-ethylhexanoic acid, isooctanoic acid or hexanoic acid.

The invention further relates to the use of the indium-tin mixed oxide powder according to the invention for the production of electrically conductive paints and coatings, solar cells and IR and UV absorbers and in medical technology.

### EXAMPLES

The BET specific surface area is determined to DIN 66131.

The average aggregate circumference, the equivalent circle diameter (ECD), the average aggregate area and the average primary particle diameter are determined by evaluation of TEM photographs. The TEM photographs are obtained using a Hitachi TEM recorder, type H-75000-2, and evaluated using the CCD camera of the TEM recorder and by subsequent image analysis.

The resistivity of the powders is measured at ambient temperature and 40% relative humidity as a function of the compressed density. For this purpose, the sample is brought between two moving electrodes and the current flux is determined after application of a direct current. The density of the powder is then progressively increased by reducing the electrode interval, and the resistivity is measured again. The measurement is taken in accordance with DIN IEC 93. The minimum resistivity is obtained with a maximum compressed density that is dependent on the substance.

The oxygen content of the powders is determined using an element determinator NOA5003, manufactured by Rose Mount.

### Example 1

Solution 1: A solution of 13 parts by weight indium nitrate (calculated as IN₂O₃) in 35 parts by weight methanol, 35 parts by weight water and 17 parts by weight acetic acid is initially produced. The pH of the solution is 2.1.

Solution 2: (Ethylhexanoate)₂Sn in 2-ethylhexanoic acid (corresponding to 29% by weight Sn). The solution is diluted with methanol to 16.6 parts by weight, based on Sn.

Solutions 1 and 2 are mixed in such a way that an indium-tin mixed oxide powder containing 88% by weight indium oxide and 12% by weight tin oxide is obtained. The combined solution is atomised through a nozzle (diameter 0.8 mm) using 5 Nm³/h nitrogen and is guided into the reaction pipe at a delivery rate of 1400 g/h. A detonating gas flame comprising 4 Nm³/h hydrogen and 15 Nm³/h primary air burns here. 15 Nm³/h secondary air are additionally supplied to the reaction pipe. The temperature 0.5 m below the flame is 765° C. The reaction mixture is then guided through a cooling section. The powder obtained is then separated from the gas stream in a known manner.

Examples 2 to 7 according to the invention are carried out in a similar manner to Example 1. The corresponding amounts of feedstock and reaction conditions are compiled in Table 1.

(Ethylhexanoate)Sn is used as the tin oxide precursor in Examples 2 to 4, dibutyl-Sn-laurate in Example 5 and (isooctanoate)₂Sn in Examples 6 and 7. Indium nitrate is dissolved in a mixture of water, methanol and acetic acid in Examples 1, 2 and 5 to 7. Indium nitrate is dissolved in a mixture of water, lactic acid and n-butanol in Example 3. The throughput of precursor solution is between 1400 and 1520 g/h.

The atomising gas is nitrogen in all examples, and the amount is 5 Nm³/h in the examples according to the invention. The amount of primary air and secondary air is 15 Nm³/h in all examples according to the invention. The throughput of precursor solution per m³ gas is between 51.6 and 57.0 g/Nm³ gas (atomising gas+primary air+hydrogen) or between 33.2 and 36.5 g/Nm³ gas (atomising gas+primary air+secondary air+hydrogen) in the examples according to the invention.

The reactor temperatures 50 cm below the flame are between 720° C. and 793° C. in the examples according to the invention.

The lambda value in the examples according to the invention is between 3.15 and 3.82.

The residence time in the examples according to the invention is between 25 and 27 milliseconds.

Examples 8 to 12 are comparison examples.

Inorganic precursors, namely indium nitrate and tin chloride dissolved in water, are used in Example 8.

The solutions of the precursors, indium nitrate in water and (ethylhexanoate)₂Sn in methanol, are guided into the flame separately in Example 9.

The lambda values lie outside the claimed range in Examples 10 and 11.

The residence time lies outside the claimed range in Example 12.

Table 2 gives the physicochemical values of the powders obtained.

The powders according to the invention from Examples 1 to 7 exhibit increasing resistivity values. However, the values are still low, even with high tin oxide contents. For example, the resistivity of the powder from Example 5 having a compressed density of 0.6 g/cm³ with a tin oxide content of 28% by weight is comparable with the powder from Example 8, which has a tin oxide content of 6% by weight.

Comparison Example 9 shows that it is essential to guide the two precursors together into the flame. A ternary nozzle is used in this example. The result is a powder with unacceptable conductivity.

The lambda value of 4.32 lies outside the claimed range in comparison Example 10. The powder obtained has a high BET specific surface area, but the resistivity is unacceptable here also.

The lambda value of 1.95 also lies outside the claimed range in comparison Example 11. Although the powder obtained has good conductivity, the BET specific surface area of 22 m²/g is too low for many applications.

The residence time of the reaction mixture of 50 ms lies outside the claimed range in comparison Example 12. The resistivity of the powder obtained is unacceptable.

Table 3 gives the values of image analysis of the powders from Examples 3, 5, 6 and 7 according to the invention.

TABLE 3
Image analysis values

| | | Examples | | | |
|---|---|---|---|---|---|
| | | 3 | 5 | 6 | 7 |
| Average aggregate area | nm² | 2848 | 4026 | 3352 | 3115 |
| Average ECD aggregates | nm | 52 | 61 | 55 | 54 |
| Average aggregate | nm | 348 | 458 | 387 | 367 |
| circumference | | | | | |
| Average maximum | nm | 85 | 100 | 91 | 89 |
| aggregate diameter | | | | | |
| Average minimum | nm | 53 | 64 | 57 | 56 |
| aggregate diameter | | | | | |
| Average primary particle | nm | 10.3 | 10.4 | 10.3 | 10.7 |
| diameter | | | | | |

TABLE 1
Feedstock and reaction conditions

| | | According to the invention | | | | | | | Comparison Examples | | | | |
|---|---|---|---|---|---|---|---|---|---|---|---|---|---|
| | | Example | | | | | | | | | | | |
| | | 1 | 2 | 3 | 4 | 5 | 6 | 7 | 8 | 9 | 10 | 11 | 12 |
| In(NO₃)₃ | wt. %^{g)} | 13 | 13 | 13 | 13 | 13 | 13 | 13 | 13 | 13 | 13 | 13 | 13 |
| Methanol | wt. % | 35 | 35 | — | 35 | 35 | 35 | 35 | — | — | 35 | 35 | 35 |
| Acetic acid | wt. % | 17 | 17 | — | 17 | 17 | 17 | 17 | — | — | 17 | 17 | 17 |
| Water | wt. % | 35 | 35 | 32 | 35 | 35 | 35 | 35 | 87 | 87 | 35 | 35 | 35 |
| Lactic acid | wt. % | — | — | 15 | — | — | — | — | — | — | — | — | — |
| n-Butanol | wt. % | — | — | 40 | — | — | — | — | — | — | — | — | — |
| (Ethylhexanoate)₂Sn^{a)} | wt. %^{h)} | 16.6 | 16.6 | 16.6 | 16.6 | — | — | — | 14.0ⁱ⁾ | 16.6 | 16.6 | 16.6 | 16.6 |
| Dibutyl-Sn-Laurate^{b)} | wt. %^{f)} | — | — | — | — | 24.9 | — | — | — | — | — | — | — |
| (Isooctanoate)₂Sn^{c)} | wt. %^{f)} | — | — | — | — | — | 16.6 | 16.6 | — | — | — | — | — |
| Throughput | g/h | 1400 | 1400 | 1400 | 1500 | 1520 | 1480 | 1460 | 1500 | 1500^{j)} | 1460 | 1470 | 1480 |
| N₂ atomisation | Nm³/h | 5 | 5 | 5 | 5 | 5 | 5 | 5 | 5 | 5 | 5 | 5 | 5 |
| Primary air | Nm³/h | 15 | 15 | 15 | 15 | 15 | 15 | 15 | 15 | 15 | 15 | 8.6 | 2.1 |
| Secondary air | Nm³/h | 15 | 15 | 15 | 15 | 15 | 15 | 15 | 15 | 15 | 20 | 10 | 10 |
| Hydrogen | Nm³/h | 4 | 3.8 | 3.5 | 3.5 | 3.5 | 3.3 | 3.3 | 4 | 4 | 3.4 | 4 | 2 |
| Lambda | | 3.15 | 3.32 | 3.60 | 3.60 | 3.60 | 3.82 | 3.82 | 3.15 | 3.15 | 4.32 | 1.95 | 3.60 |
| Throughput/amount of | g/Nm³ | 51.6 | 51.9 | 52.5 | 56.3 | 57.0 | 56.0 | 55.2 | 55.2 | — | 55.0 | 75.7 | 155 |
| gas 1^{d)} | | | | | | | | | | | | | |
| Throughput/amount of | g/Nm³ | 33.2 | 33.4 | 33.6 | 36 | 36.5 | 35.7 | 35.2 | 35.6 | — | 31.4 | 50 | 75.7 |
| gas 2^{e)} | | | | | | | | | | | | | |
| Reactor temp. top^{f)} | ° C. | 765 | 733 | 787 | 720 | 764 | 793 | 771 | 759 | 762 | 673 | 921 | 817 |
| Residence time | ms | 27 | 26 | 25 | 25 | 25 | 25 | 25 | 22 | 22 | 18 | 32 | 50 |

^{a)}MeCH(Et)(CH₂)₄]₂Sn in MeOH;
^{b)}(nBu)₂Sn[(Me(CH₂)₁₀CO₂]₂ in MeOH;
^{c)}[Me₂CH(CH₂)₅]₂Sn in MeOH;
^{d)}amount of gas 1 = atomising gas + primary air + hydrogen;
^{e)}amount of gas 2 = amount of gas 1 + secondary air;
^{f)}50 cm below flame;
^{g)}as In₂O₃;
^{h)}as SnO₂;
ⁱ⁾SnCl₄×5H₂O in water;
^{j)}90 g/h Sn-solution + 1410 g/h In-solution.

TABLE 2
Physicochemical values of indium-tin mixed oxide powders

| | | According to the invention | | | | | | | Comparison Examples | | | | |
|---|---|---|---|---|---|---|---|---|---|---|---|---|---|
| | | 1 | 2 | 3 | 4 | 5 | 6 | 7 | 8 | 9 | 10 | 11 | 12 |
| BET specific surface | m²/g | 47 | 47 | 55 | 54 | 54 | 54 | 54 | 53 | 60 | 75 | 22 | 49 |
| area | | | | | | | | | | | | | |
| SnO₂ content | wt. % | 12 | 16 | 20 | 24 | 28 | 36 | 40 | 6 | 6 | 24 | 24 | 24 |
| In₂O₃ content | wt. % | 88 | 84 | 80 | 76 | 72 | 64 | 60 | 94 | 94 | 76 | 76 | 76 |
| O₂-content | wt. % | 17.7 | 17.8 | 18.0 | 18.2 | 18.4 | 18.7 | 18.8 | 17.4 | 17.4 | 18.2 | 18.2 | 18.2 |
| (theoretical)^{a)} | | | | | | | | | | | | | |
| O₂-content (found) | wt. % | 17.7 | 17.9 | 19.5 | 18.2 | 18.5 | 18.7 | 18.7 | 17.0 | 17.1 | 18.0 | 18.2 | 18.0 |
| C-content | wt. % | 0.15 | 0.16 | 0.1 | 0.11 | 0.13 | 0.6 | 0.08 | 0.06 | 0.09 | 0.23 | 0.08 | 0.15 |
| Minimum resistivity | ohm · cm | 2 | 4 | 7 | 9 | 18 | 39 | 111 | 4 | 118 | 127 | 9 | 41 |
| Resistivity at 0.6 g/cm³ | ohm · cm | 28 | 34 | 38 | 54 | 127 | 577 | 693 | 111 | 1710 | 1496 | 54 | 603 |

^{a)}(wt. % SnO₂ · 0.2129 + wt. % In₂O₃ · 0.1721) · 100

1-10. (canceled)

11. An indium-tin mixed oxide powder, characterised in that it consists of primary particle aggregates and contains 50 to 90° by weight indium oxide, calculated as In₂O₃, and 10 to 50% by weight tin oxide, calculated as SnO₂.

12. The indium-tin mixed oxide powder according to claim 11, characterised in that it contains 60 to 85% by weight indium oxide, calculated as In₂O₃, and 5 to 40% by weight tin oxide, calculated as SnO₂.

13. The indium-tin mixed oxide powder according to claim 11, characterised in that it contains less than 0.3% by weight carbon.

14. The indium-tin mixed oxide powder according to claim 12, characterised in that it contains less than 0.3% by weight carbon.

15. The indium-tin mixed oxide powder according to claim 11, characterised in that it contains up to 3% by weight, based on the total amount of powder, of one or more or metals and/or metal oxides as doping component.

16. The indium-tin mixed oxide powder according to claim 11, characterised in that it has an average aggregate area of 1500 to 4500 nm², an average equivalent diameter (ECD) of 30 to 70 nm and an average aggregate diameter of 200 to 600 nm.

17. The indium-tin mixed oxide powder according to claim 11, characterised in that it has an average minimum diameter of 30 to 70 nm and average maximum diameter of 60 to 120 nm.

18. The indium-tin mixed oxide powder according to claim 11, characterised in that it has a BET specific surface area of 30 to 70 m²/g.

19. The indium-tin mixed oxide powder according to claim 11, characterised in that it shows only one indium oxide phase in X-ray analysis.

20. A process for producing the indium-tin mixed oxide powder according to claim 11, characterised in that, as the indium oxide precursor, an inorganic indium compound, which contains no Chlorine atoms, dissolved in a mixture of water and a solvent selected from the group consisting of C₁ to C₆ alcohols, C₁ to C₆ diols and/or C₁ to C₆ glycolmonoalkylethers, wherein the pH of the solution is optionally adjusted to a value of 3≧pH≧1 using an acid, and, as the tin oxide precursor, an organic tin compound, dissolved in at least one solvent selected from the group consisting of C₁ to C₆ alcohols, C₁ to C₆ diols, C₁ to C₆ glycolmonoalkylethers and/or C t C t carboxylic acid, said process comprising the steps of:
combining said indium oxide precursor and said tin oxide precursor to form a precursor solution, the respective precursor content in the combined solution being not more than 20% by weight of indium and tin, based on In₂O₃ and SnO₂, and the precursor content corresponding to the subsequently desired ratio of mixed oxide components,
atomizing said precursor solution with air or an inert carrier gas, using a nozzle,
mixing the atomized precursor solution with a fuel gas and air (primary air),
burning the mixture of fuel gas, air (primary air) and atomized precursor solution in a flame in a reaction pipe, and
cooling the hot gases and the solid products and subsequently separating the solid products from the gases,
wherein
the proportion of precursor solution in the total quantity of gas consisting of atomising gas, air (primary air) and fuel gas is from 10 to 100 g solution/Nm³ gas,
lambda, defined as the ratio of oxygen present from the air used for combustion of the fuel gas to oxygen required for combustion of the fuel gas, is 2 to 4.5
the precursors remain in the flame for a residence time of 5 to 30 milliseconds and
the temperature of the reaction mixture 0.5 m below the flame is 700 to 800° C.

21. A method of using the indium-tin mixed oxide powder according to claim 11 for producing electrically conductive paints and coatings, solar cells and IR and UV absorbers and in medical technology.
